(19) United States
(12) Patent Application Publication
(10) Pub. No.: US 2014/0015924 A1
(43) Pub. Date: Jan. 16, 2014

(54) Rapid 3D Modeling

(71) Applicant: Adam Pryor, Paddington (AU)

(72) Inventor: Adam Pryor, Paddington (AU)

(73) Assignee: SUNGEVITY, INC.

(21) Appl. No.: 13/878,106

(22) PCT Filed: Oct. 7, 2011
(86) PCT No.: PCT/US11/55489

§ 371 Date: Oct. 4, 2013

Related U.S. Application Data
(60) Provisional application No. 61/391,069, filed on Oct. 7, 2010.

(51) Int. Cl. H04N 13/00

(52) U.S. Cl. CPC H04N 13/0018
USPC 348/43

(57) ABSTRACT

The invention provides a system and method for rapid, efficient 3D modeling of real world 3D objects. A 3D model is generated based on as few as two photographs of an object of interest. Each of the two photographs may be obtained using a conventional pin-hole camera device. A system according to an embodiment of the invention includes a novel camera modeler and an efficient method for correcting errors in camera parameters. Other applications for the invention include rapid 3D modeling for animated and real-life motion pictures and video games, as well as for architectural and medical applications.

### CROSS REFERENCE TO RELATED APPLICATIONS

This application claims the benefit of priority to provisional application Ser. No. 61/391,069, titled ‘Rapid 3D Modeling’ naming the same inventor and filed in the USPTO on Oct. 7, 2010, the contents of which are incorporated herein in their entirety, including any appendices, by reference.

### BACKGROUND OF THE INVENTION

Three dimensional (3D) models represent the three dimensions of real world objects as stored geometric data. The models can be used for rendering two dimensional (2D) graphical images of the real world objects. Interaction with a rendered 2D image of an object on a display device simulates interaction with the real world object by applying calculations to the dimensional data stored in the object's 3D model. Simulated interaction with an object is useful when physical interaction with the object in the real world is not possible, dangerous, impractical or otherwise undesirable.

Conventional methods of producing a 3D model of an object include originating the model on a computer by an artist or engineer using a 3D modeling tool. This method is time consuming and requires a skilled operator to implement. 3D models can also be produced by scanning the model into the computer from a real world object. A typical 3D scanner collects distance information about an object's surfaces within its field of view. The “picture” produced by a 3D scanner describes the distance to a surface at each point in the picture. This allows the three dimensional position of each point in the picture to be identified. This technique typically requires multiple scans from many different directions to obtain information about all sides of the object. These techniques are useful in many applications.

Still, a wide variety of applications would benefit from systems and methods that could rapidly generate 3D models without the need for engineering expertise, and without relying of expensive and time consuming scanning equipment. One example is found in the field of solar energy system installation. In order to select appropriate solar panels for installation on a structure, e.g., a roof of a house, it is necessary to know the roof dimensions. In conventional installations, a technician is dispatched to the site of the installation to physically inspect and measure the installation area to determine its dimensions. A site visit is time consuming and costly. In some cases a site visit is impractical. For example, inclement weather can cause extended delays. A site may be located at a considerable distance from the nearest technician, or may otherwise be difficult to access. It would be useful to have systems and methods that allow structural measurements to be obtained from a 3D model rendered on a display screen, instead of traveling to and physically measuring a real world structure.

Some consumers are reluctant to outfit their homes with solar energy systems due to uncertainty about the cosmetic effect of solar panels when installed on a roof. Some consumers would prefer to participate in any decisions about where the panels are placed for other reasons, such as concern about obstructions. These concerns can present obstacles to the adoption of solar energy. What are needed are systems and methods that rapidly provide realistic visual representations of specific solar components as they would appear installed on a given home

Various embodiments of the invention rapidly generate 3D models that allow remote measurement as well as visualization, manipulation, and interaction with realistic rendered 3D graphics images of real world 3D objects.

### SUMMARY OF THE INVENTION

The invention provides a system and method for rapid, efficient 3D modeling of real world 3D objects. A 3D model is generated based on as few as two photographs of an object of interest. Each of the two photographs may be obtained using a conventional pin-hole camera device. A system according to an embodiment of the invention includes a novel camera modeler and an efficient method for correcting errors in camera parameters. Other applications for the invention include rapid 3D modeling for animated and real-life motion pictures and video games, as well as for architectural and medical applications.

### DESCRIPTION OF THE DRAWING FIGURES

These and other objects, features and advantages of the invention will be apparent from a consideration of the following detailed description of the invention considered in conjunction with the drawing figures, in which:

FIG. 1 is a diagram illustrating an example deployment of an embodiment of the 3D modeling system of the invention;

FIG. 2 is a flow chart illustrating a method according to an embodiment of the invention;

FIG. 3 illustrates an example first image including a top down view of an object comprising a roof of a house, suitable for use in an example embodiment of the invention;

FIG. 4 illustrates an example second image including a front elevation view of the house whose roof is depicted in FIG. 3 suitable for use in some example embodiments of the invention;

FIG. 5 is a table comprising example 2D point sets corresponding to example 3D points in the first and second images illustrated in FIGS. 3 and 4;

FIG. 6 illustrates an example list of 3D points comprising right angles selected from the example first and second images illustrated in FIGS. 3 and 4;

FIG. 7 illustrates a an example of 3D points comprising ground planes selected from the example first and second images illustrated in FIGS. 3 and 4;

FIG. 8 is a flow chart of a method for generating 3D points according to an embodiment of the invention;

FIG. 9 is a flowchart of a method of estimating error according to an embodiment of the invention;

FIG. 10 is a conceptual illustration of the function of an example camera parameter generator suitable for providing camera parameters to a camera modeler according to embodiments of the invention;

FIG. 11 is a flow chart illustrating steps of a method for generating initial first camera parameters for a camera modeler according to an embodiment of the invention;

FIG. 12 is a flow chart illustrating steps of a method for generating second camera parameters for a camera modeler according to an embodiment of the invention;

FIG. 13 illustrates an example image of an object displayed in an example graphical user interface (GUI) provided on a display device and enabling an operator to generate point sets for the object according to an embodiment of the invention;

FIG. 14 illustrates steps for providing an error corrected 3D model of an object according to an embodiment of the invention;

FIG. 15 illustrates steps for providing an error corrected 3D model of an object according to an alternative embodiment of the invention;

FIG. 16 is a conceptual diagram illustrating an example 3D model generator providing a 3D model based projection of point sets from first and second images according to an embodiment of the invention;

FIG. 17 illustrates an example 3D model space defined by example first and second cameras wherein one of the first and second cameras is initialized in accordance with a top plan view according to an embodiment of the invention;

FIG. 18 illustrates and describes steps of a method for providing corrected camera parameters according to an embodiment of the invention;

FIG. 19 is a conceptual diagram illustrating the relationship between first and second images, a camera modeler and a model generator according to an embodiment of the invention;

FIG. 20 illustrates steps of a method for generating and storing a 3D model according to an embodiment of the invention;

FIG. 21 illustrates a 3D model generating system according to an embodiment of the invention;

FIG. 22 is a flow chart illustrating a method for adjusting camera parameters according to an embodiment of the invention;

FIG. 23 is a block diagram of an example 3D modeling system according to an embodiment of the invention;

FIG. 24 is a block diagram of an example 3D modeling system cooperating with an auxiliary object sizing system according an embodiment of the invention.

### DETAILED DESCRIPTION OF THE INVENTION

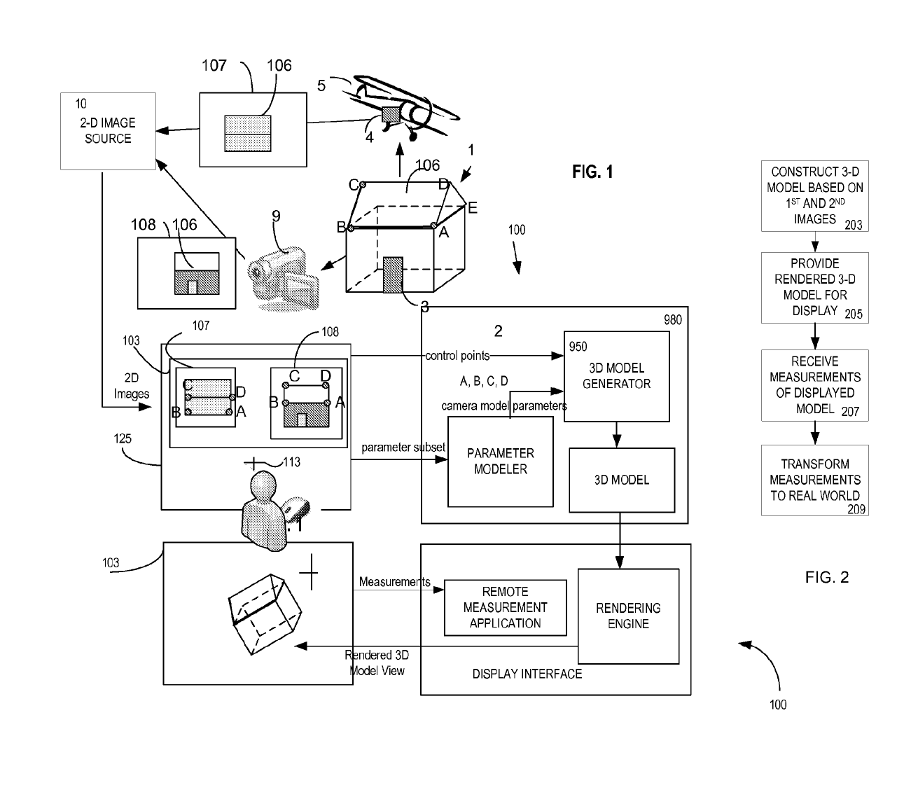

### FIG. 1

FIG. 1 illustrates an embodiment of the invention deployed in a structure measuring system. An image source 10 comprises photographic images including images of a real world 3D residential structure 1. In some embodiments of the invention a suitable 2D image source comprises a collection of 2D images stored in graphic formats such as JPEG, TIFF, GIF, RAW and other image storage formats. Some embodiments of the invention receive at least one image comprising a bird's-eye view of a structure. A ‘bird's-eye view offers aerial photos from four angles.

In some embodiments of the invention suitable 2D images include aerial and satellite images. In one embodiment of the invention, 2D image source is an online database accessible by system 200 via the interne. Examples of suitable online sources of 2D images include, but are not limited to the United States Geographical Survey (USGS), The Maryland Global Land Cover Facility and TerraServer-USA (recently renamed Microsoft Research Maps (MSR). These databases store maps and aerial photographs.

In some embodiments of the invention, images are geo-referenced. A geo referenced image contains information, either within itself, or in a supplementary file (e.g., a world file), that indicates to a GIS system, how to align the image with other data. Formats suitable for geo-referencing include GeoTiff, jp2, and MrSid. Other images may carry geo-referencing information in a companion file (known in ArcGIS as a world file, which is normally a small text file with the same name and suffix of the image file. Images are manually geo-referenced for use in some embodiments of the invention. High resolution images are available from subscription databases such as Google Earth Pro™ Mapquest™ is suitable for some embodiments of the invention. In some embodiments of the invention, geo-referenced images are received that include Geographic Information Systems (GIS) information.

Images of structure 1 have been captured, for example by aircraft 5 taking aerial photographs of structure 1 using an airborne image capture device, such as an airborne camera 4. An example photograph 107 taken by camera 4 is a top down view of a roof 106 of residential structure 1. The example photograph 107 obtained by camera 4 is a top plan view of the roof 106 of residential structure 1. However, the invention is not limited to top down views. Camera 4 may also capture orthographic and oblique views, and other views of structure 1.

Images comprising image source 10 need not be limited to aerial photographs. For example, additional images of structure 1 are captured on the ground via a second camera, e.g., a ground based camera 9. Ground based images include, but are not limited to front, side and rear elevation views of structure 1. FIG. 1 depicts a second photograph 108 of structure 1. In this illustration photograph 108 presents a front elevation view of structure 1.

According to embodiments of the invention, the first and second views of an object need not be captured with any specific type of image capture device. Images captured from different capture devices at different times, and for different purposes will be suitable for use in the various embodiments of the invention. Image capture devices from which first and second images are derived need not have any particular intrinsic or extrinsic camera attributes in common. The invention does not rely on knowledge of intrinsic or extrinsic camera attributes for actual cameras used to capture first and second images.

Once images are stored in image source 10, they are available for selection and download to system 100. In an example use, operator 113 obtains a street address from a customer. Operator 113 may use an image management unit 103 to access a source of images 10, for example, via the Internet. Operator 113 may obtain an image by providing a street address. Image source 10 responds by providing a plurality of views of a home located at the given street address. Suitable views for use with various embodiments of the invention include top plan views, elevation views, perspective views, orthographic projections, oblique images and other types of images and views.

In this example, first image 107 presents a first view of house 1. The first view presents a top plan view of a roof of house 1. The second image 108 presents a second view of the same house 1. The second image presents the roof from a different viewpoint than that shown in the first view. Therefore, the first image 107 comprises an image of an object 1 in a first orientation in 2-D space, and the second image 108 comprises an image of the same object 1 in a second orientation in 2D space. In some implementations of the invention at least one image comprises a top plan view of an object. First image 107 and second image 108 may differ from each other with respect to size, aspect ratio, and other characteristics of the object 1 represented in the images.

When it is desired to measure dimensions of structure 1, first and second images of the structure are obtained from image source 10. It is significant to note that information about cameras 4 and 9 providing the first and second images is not necessarily stored in image source 10, nor is it necessarily provided with a retrieved image. In many cases, no information about cameras used to take the first and second photographs is available from any source. Embodiments of the invention are capable of determining information about the first and second cameras based on the first and second images regardless of whether or not information about the actual first and second cameras is available.

In one embodiment first and second images of the house are received by system 100 and displayed to an operator 113. Operator 113 interacts with the images to generate point sets (control points) to be provided to 3D model generator 950. Model generator 950 provides a 3D model of the object. The 3D model is rendered for display on a 2D display device 103 by a rendering engine. Operator 113 measures dimensions of the object displayed on display 103 using a measuring application to interact with the displayed object. The model measurements are converted to real world measurements based on information about the scale of the first and second images. Thus measurements of the real world object are made without the need to visit the site. Embodiments of the invention are capable of generating a 3D model of a structure based on at least two photographic images of the object.

### FIG. 2

FIG. 2 illustrates and describes a method for measuring a real world object based on a 3D model of the object according to an embodiment of the invention.

At step 203 a 3D model of the structure to be measured is generated. At step 205, the model is rendered on a display device such that an operator is enabled to interact with the displayed image to measure dimensions of the image. At step 207 the measurements are received. At step 209 the measurements are transformed from image measurements to real world measurement. At that point, the measurements are suitable for use in provisioning a solar energy system to the structure.

To carry out step 203 a model generator of the invention receives the matching points and generates a 3D model. The 3D model is refined by applying a novel optimization technique to the reconstructed 3D structure. The refined 3D model represents the real world structure with sufficient accuracy to enable usable measurements of the structure to be obtained by measuring the refined 3D model.

To accomplish this, the 3D model is rendered on display device 103. Dimensions of the displayed model are measured. The measurements are converted to real world measurements. The real world measurements are used by a solar energy provisioning system to provision the structure with solar panels.

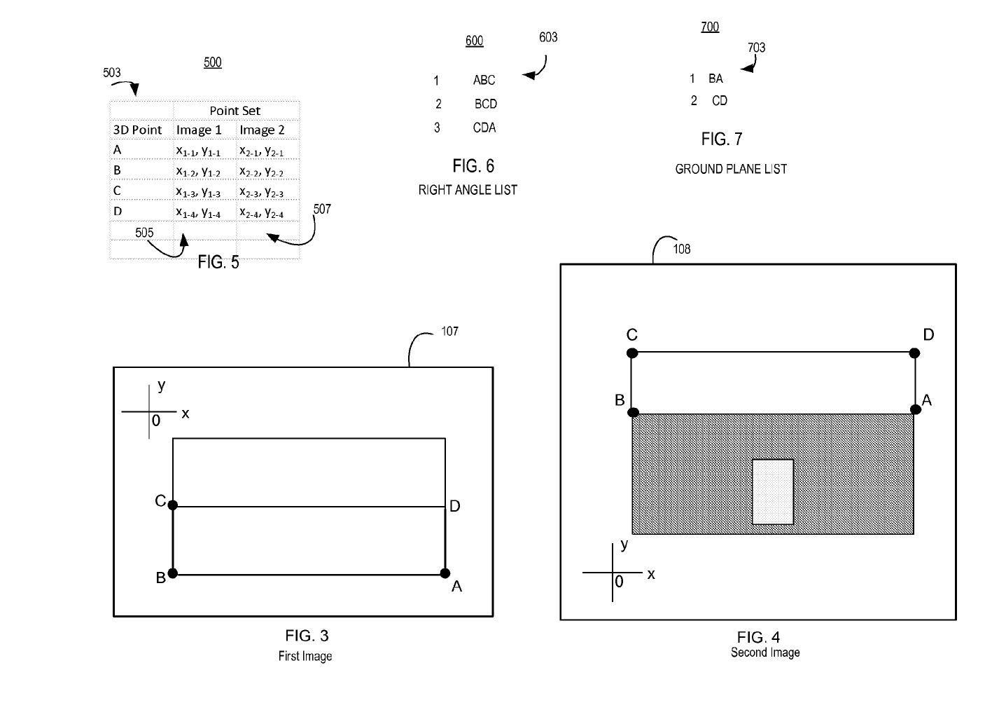

### FIGS. 3 and 4

Examples of suitable first and second images are illustrated in FIGS. 3 and 4. FIG. 3 illustrates a first image 107 comprising a top plan view of a roof of a house. For example, first image 107 is a photograph taken by a camera positioned over the roof of a structure so as to capture a top plan view of the roof. In the simplest embodiment, two dimensional first image 107 is presumed to have been captured by a conventional method of projecting the three dimensional object, in this case a house, onto a 2 dimensional image plane.

FIG. 4 illustrates a second image 108 comprising a front elevation view of the house illustrated in FIG. 3 including the roof illustrated in FIG. 3. It is significant to note the first and second images need not be stereoscopic images. Further, the first and second images need not be scanned images. In one embodiment of the invention, the first and second photographic images are captured by image capture devices such as cameras.

For purposes of this specification the term ‘photograph’ refers to an image created by light falling on a light-sensitive surface. Light sensitive surfaces include photographic film and electronic imagers such as Charge Coupled Device (CCD) or Complementary Metal Oxide Semiconductor (CMOS) imaging devices. For purposes of this specification, photographs are created using a camera. A camera refers to a device including a lens to focus a scene's visible wavelengths of light into a reproduction of what the human eye would see.

In one embodiment of the invention first image 107 comprises an orthographic projection of the real world object to be measured. Generally an image-capturing device, such as a camera or sensor, is carried by a vehicle or platform, such as an airplane or satellite, and is aimed at a nadir point that is directly below and/or vertically downward from that platform. The point or pixel in the image that corresponds to the nadir point is the point/pixel that is orthogonal to the image-capturing device. All other points or pixels in the image are oblique relative to the image-capturing device. As the points or pixels become increasingly distant from the nadir point they become increasingly oblique relative to the image-capturing device. Likewise the ground sample distance (i.e., the surface area corresponding to or covered by each pixel) also increases. Such obliqueness in an orthogonal image causes features in the image to be distorted, especially images relatively distant from the nadir point.

To project a 3D point aₓ, a_{y}, a_{z} from the real world image onto the corresponding 2D point bₓ, b_{y} using an orthographic projection parallel to the y axis (profile view), a corresponding camera model may be described by the following example relationships:

bₓ=sₓaₓ+cₓ

b_{y}=s_{z}a_{z}+c_{z}

where the vector s is an arbitrary scale factor, and c is an arbitrary offset. In some embodiments of the invention, these constants are used to align the first camera model viewport to match the view presented in first image 105. Using matrix multiplication, the equations become:

$$[ \begin{matrix}{b}_{x} \\ {b}_{y}\end{matrix} ] = [ \begin{matrix}{s}_{x} & 0 & 0 \\ 0 & 0 & {s}_{z}\end{matrix} ] [ \begin{matrix}{a}_{x} \\ {a}_{y} \\ {a}_{z}\end{matrix} ] + [ \begin{matrix}{c}_{x} \\ {c}_{z}\end{matrix} ]$$

In one embodiment of the invention an orthogonal image is corrected for distortion. For example, distortion is removed, or compensated for, by the process of ortho-rectification which, in essence, removes the obliqueness from the orthogonal image by fitting or warping each pixel of an orthogonal image onto an orthometric grid or coordinate system. The process of ortho-rectification creates an image wherein all pixels have the same ground sample distance and are oriented to the north. Thus, any point on an ortho-rectified image can be located using an X, Y coordinate system and, so long as the image scale is known, the length and width of terrestrial features as well as the relative distance between those features can be calculated.

In one embodiment of the invention one of the first and second images comprises an oblique image. Oblique images may be captured with the image-capturing device aimed or pointed generally to the side of and downward from the platform that carries the image-capturing device. Oblique images, unlike orthogonal images, display the sides of terrestrial features, such as houses, buildings and/or mountains, as well as the tops thereof. Each pixel in the foreground of an oblique image corresponds to a relatively small area of the surface or object depicted (i.e., each foreground pixel has a relatively small ground sample distance) whereas each pixel in the background corresponds to a relatively large area of the surface or object depicted (i.e., each background pixel has a relatively large ground sample distance). Oblique images capture a generally trapezoidal area or view of the subject surface or object, with the foreground of the trapezoid having a substantially smaller ground sample distance (i.e., a higher resolution) than the background of the trapezoid.

### FIG. 5

Once first and second images are selected and displayed point sets (control points) are selected. Selection of point sets is accomplished manually in some embodiments of the invention, for example by an operator. In other embodiments of the invention, control points may be automatically selected, for example by machine vision feature matching techniques. For manual embodiments an operator selects a point in the first image and a corresponding point in the second image wherein both points represent the same point in the real world 3D structure.

To identify and indicate matching points, operator 113 interacts with the first and second displayed images to indicate corresponding points on the displayed first and second images. In the example of FIGS. 3 and 4, point A of real world 3D structure 1 indicates a right corner of roof 1. Point A appears in first image 107 and in second image 108, though in different positions on the displayed images.

In order to indicate corresponding points in the first and second images operator places displayed indicia over corresponding portions of an object in each of 1^{st} and 2^{nd} images 105, 107. For example, indicia is place over point A of object 102 in first image 105, and then placed over corresponding point A of object 102 in 2^{nd} image 107. At each point the operator indicates selection of the point, for example, by right or left mouse click or operation of other selection mechanism. Other devices such as trackballs, keyboards, light pens, touch screens, joysticks and the like are suitable for use in embodiments of the invention. Thus the operator interacts with the first and second images to produce control point pairs as illustrated in FIG. 5.

In one example embodiment of the invention, a touch screen display may be employed. In that case, an operator selects a point or other region of interest in a displayed image by touching the screen. The pixel coordinates are translated from a display screen coordinate description to, for example, a coordinate system description corresponding to the image containing the sensed touched pixels. In other embodiments of the invention, an operator uses a mouse to place a marker, or other indicator, over a point to be selected on an image. Clicking the mouse records the pixel coordinates of the placed marker. System 100 translates the pixel coordinates to corresponding image coordinates.

The control points are provided to a 3D model generator 950 of a 3D modeling system of the invention. Reconstruction of an imaged structure is accomplished by finding intersections of epipolar lines for each point pair.

### FIGS. 6 and 7

FIG. 7 illustrates points defining ground planes. In some embodiments of the invention a generated 3D model is refined by reference to ground parallels. FIG. 7 illustrates an example list of control points from the example list of control points illustrated in FIG. 5 wherein the control points in FIG. 7 comprise ground parallel lines according to an embodiment of the invention.

FIG. 6 illustrates points defining right angles associated with the object. Like ground planes, right angles may be used in some embodiments of the invention to refine a 3D model.

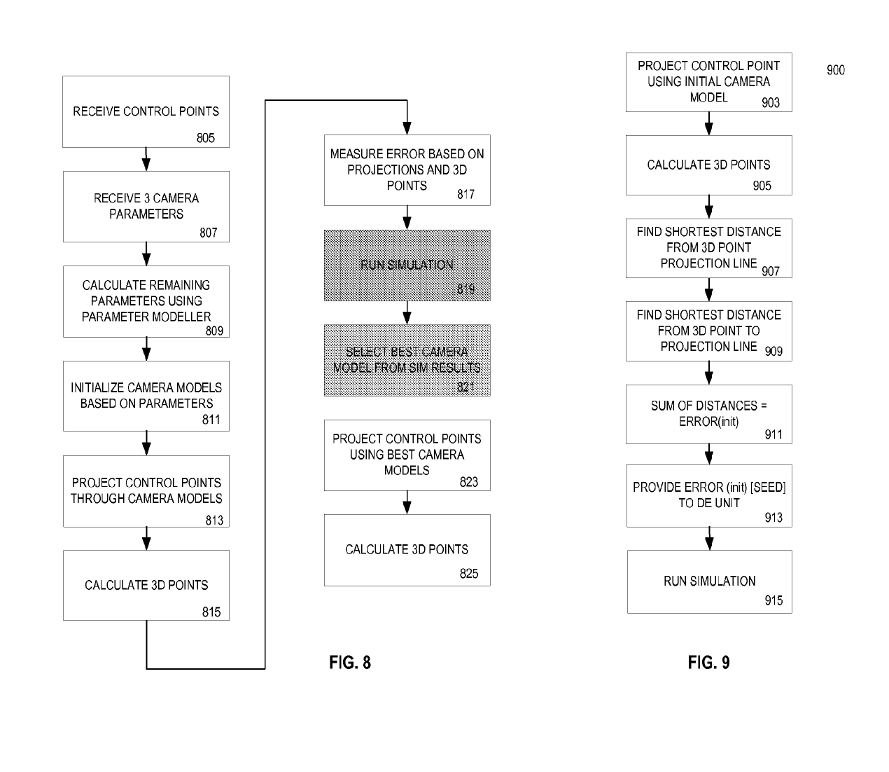

### FIG. 8

FIG. 8 illustrates a system of the invention. As explained with respect to FIGS. 1-7 an operator selects first and second image point sets from first and second images displayed on a display device 803. A first camera matrix (Camera 1) receives point sets from the first image. A second camera matrix (Camera 2) receives point sets from the second image. Model generation is initiated by providing initial parameters for Camera 1 and Camera 2 matrices.

In one embodiment of the invention camera parameters comprise the following intrinsic paramters:

a.) (u0,v0): coordinates in pixels of the image center which is the projection of the camera center on the retina.

b.) (au,av): scale factors of the image.

c.) (dimx, dimy): size in pixels of the image.

External parameters are defined herein as follows:

a.) R: rotation which gives axes of the camera in the reference coordinate system.

b) T: pose in mm of the camera center in the reference coordinate system.

A camera parameter modeling unit 815 is configured to provide camera models (matrix) corresponding to the first and second images. The camera models are a description of the cameras used to capture the 1^{st} and 2^{nd} images. The camera parameter model of the invention models the first and second camera matrices to include camera constraints. The parameter model of the invention accounts for parameters that are unlikely to occur or are invalid, for example, a camera position that would point a lens in a direction away from an object seen in an image. Thus, those parameter values need not be considered in computations of test parameters.

The camera parameter modeling unit is configured to model relationships and constraints describe relationships between the parameters comprising the first and second parameter sets based, at least in part on the attributes of the selected first and second images.

The camera parameter model 1000 of the invention embodies sufficient information about position constraints on the first and second cameras to prevent selection of invalid or unlikely sub-combinations of camera parameters. Thus computational time to generate a 3D model is less that it would be if parameters values for, e.g., impossible or otherwise invalid or unlikely camera positions were included in the test parameters.

In some embodiments, to describe orientation of the first and second cameras in 3-dimensional Euclidean space, three parameters are employed. Various embodiments of the invention represent camera orientation in different ways. For example, in one embodiment of the invention, a camera parameter model represents camera positions by Euler angles. Euler angles are three angles describing the orientation of a rigid body. In those embodiments a coordinate system for a 3D model space describes camera positions as if there were real gimbals defining camera angles comprising Euler angles.

Euler angles also represent three composed rotations that move the reference (camera) frame to the referred (3D model) frame. Thus any orientation can be represented by composing three elemental rotations (rotations around a single axis), and any rotation matrix can be decomposed as a product of three elemental rotation matrices.

L

For each point in a point pair, model unit 303 projects a line of sight (or ray) through the corresponding hypothetical camera that captured the image containing the point. The line passing through the first image epipole and the line passing through the second image epipole would intersect under ideal conditions, e.g., when the camera model accurately represents the actual camera employed to capture the image, when noise is absent, and when the identification of point pairs was accurate and consistent between the first and second photographs.

3D model unit 303 determines the intersection of the rays projected through the first and second camera models using a triangulation technique in one embodiment of the invention. In general, triangulation is the process of determining the location of a point by measuring angles to it from known points at either end of a fixed baseline, rather than measuring distances to the point directly. The point can then be fixed as the third point of a triangle with one known side and two known angles. The coordinates and distance to a point can be found by calculating the length of one side of a triangle, given measurements of angles and sides of the triangle formed by that point and two other known reference points. In an error-free context, the intersection coordinates comprises the three-dimensional location of the point in 3D model space.

According to some embodiments of the invention a 3D model comprises a three-dimensional representation of the real world structure, wherein the representation comprises geometric data referenced to a coordinate system, e.g., a Cartesian coordinate system. In some embodiments of the invention a 3-D model comprises a graphical data file. The 3-D representation is stored in a memory of a processor (not shown) for the purposes of performing calculations and measurements.

A 3D model can be displayed visually as a two-dimensional image through a 3D rendering process. Once a system of the invention generates a 3D model, a rendering engine 995 and renders 2D images of the model on display device 103. Conventional rendering techniques are suitable for use in embodiments of the invention. Besides rendering, a 3D model is otherwise useful in graphical or non-graphical computer simulations and calculations. Rendered 2-D images may be stored for viewing later. However, embodiments of the invention described herein enable rendered 2-D images to be displayed in near real-time on display 103 as operator 113 indicates control point pairs.

The 3D co-ordinates comprising the 3D model define the locations of structure points in the 3D real world space. In contrast, image co-ordinates define the locations of the structures image points on the film or an electronic imaging device.

Point coordinates are translated between 3D image coordinates and 3D model coordinates. For example, the distance between two points lying on a plane parallel to a photographic image plane can be determined by measuring their distance on the image, if the scale s of the image is known. The measured distance is multiplied by 1/s. In some embodiments of the invention, scale information for either or both of the first and second images are known, e.g., by receiving scale information as metadata with the downloaded images. The scale information is stored for use by measurement unit 119. Thus, measurement unit 119 enables operator 113 to measure the real world 3D object by measuring the model rendered on display device 103.

Operator 61 selects at least two images for download to system 100. In one embodiment of the invention, a first selected image is a top plan view of the home. A second selected image is a perspective view of the home. Operator 61 displays both images on display device 70. Using a mouse, or other suitable input device, operator 61 selects sets of points on the first and second images. For every point selected in the first image, a corresponding point is selected in the second image. As described above, system 100 enables an operator 109 to interact with and manipulate 2 dimensional (2-D) images displayed on 2-D display device 103. In the simplified example of FIG. 1 at least one 2-D image, e.g., first photographic image 105 is acquired from a source of images 10 via a processor 112. In other embodiments of the invention a suitable source of 2-D images is stored in processor 112, and selectable by operator 109 for display on display device 103. The invention is not limited with regard to the number and type of images sources employed. Rather, a variety of image sources 10 are suitable for comprising 2-D images for acquisition and display on display device 103.

For example, in the example embodiment described above the invention is deployed to remotely measure dimensions of residential structures based on images of the structures. In those embodiments commercial geographic image databases such as those maintained by Microsoft™ are suitable sources of 2-D images. Some embodiments of the invention will rely on more than one source of 2-D images. For example, first image 105 is selected from a first image source, and second image 107 is selected from a second unrelated image source. Images obtained by consumer grade imaging devices, e.g., disposable cameras, video cameras and the like are suitable for use in embodiments of the invention. Likewise, professional images obtained by satellite, geographic survey imaging equipment, and a variety of other imaging equipment providing commercial grade 2-D images of real world objects are suitable for use in the various embodiments of the invention.

According to one alternative embodiment, 1^{st} and 2^{nd} images are scanned using a local scanner coupled to processor 112. Scan data for each scanned image is provided to processor 112. The scanned images are displayed to operator 109 on display device 103. In another alternative embodiment, imaging capture equipment is located on the site at which the real world house is located. In that case, image capture equipment provides images to processor 112 via the Internet. The images may be provided in real time, or stored to be provided at a future time. Another source of images is an image archiving and communications system connected to processor 112 via a data network. A wide variety of methods and apparatus capable of generating or delivering images are suitable for use with various embodiments of the invention.

### Refining the Model

In practice, epipolar geometry is imperfectly embodied in a real photograph. 2-D coordinates of control points from the first and second images cannot be measured with arbitrary accuracy. Various types of noise, such as geometric noise from lens distortion or interest point detection error, lead to inaccuracies in the control point coordinates. In addition, the geometry of first and second cameras is not perfectly known. As a consequence, the lines projected by 3D model generator from the corresponding control points via the first and second camera matrices do not always intersect in 3D space when triangulated. In that case, an estimate of the 3D coordinates is made based on an evaluation of the relative line position of the lines projected by the 3D model generator. In one embodiment of the invention, the estimated 3D point is determined by identifying a point in 3D model space representing the closest proximal relationship of the first control point projection to the second control point projection.

This estimated 3D point will have an error proportional to its deviation from the same point on the real world structure, had a direct and error free measurement been made of the real world structure. In some embodiments of the invention the estimated error represents the deviation of the estimated point from the 3D point that would have resulted from a noise-free, distortion-free, error-free projection of a control point pair. In other embodiments of the invention the estimated error represents the deviation of the estimated point from the 3D point that represents the ‘best estimate’ of the real world 3D point based on criteria defined externally, such as by an operator, in the generation of the 3D model.

Re-projection error is a geometric error corresponding to the image distance between a projected point and a measured one. Reprojection quantifies how closely an estimate of a 3D point \hat{X} recreates the point's true projection x. More precisely, let P be the projection matrix of a camera and \hat{x} be the image projection of \hat{X}, i.e. \hat{x}=P\hat{X}. The reprojection error of \hat{X} is given by d(x, \hat{x}), where d(x, \hat{x}) denotes the Euclidean distance between the image points represented by vectors x and \hat{x}.

To generate a 3D model representing, as closely as possible, the modeled 3D real world structure, is would be desirable to minimize re-projection error. Therefore, in order to produce a 3D model with an accuracy sufficient to measure dimensions, e.g., for the purpose of installing solar panels, embodiments of the invention adjust first and second camera descriptions to bring the projected lines as close as possible to intersection while ensuring the estimated 3D point lies within the constraints of the camera parameter model.

In one embodiment of the invention the 3D model coordinates generated as described above are refined. Given a number of 3D points comprising a 3D model generated by projecting control point pairs through a camera model, the camera parameters and the 3D points comprising the model are adjusted until the 3D model meets an optimality criterion involving the corresponding image projections of all points. It amounts to an optimization problem on the 3D image and viewing parameters (i.e., camera pose and possibly intrinsic calibration and radial distortion), to obtain a reconstruction which is optimal under the constraints of the parameter model. The technique of the invention effectively minimizes the reprojection error between the image locations of observed and predicted image points, which is expressed as the sum of squares of a large number of nonlinear, real-valued functions. This type of minimization is typically achieved using nonlinear least-squares algorithms. Of these, Levenberg-Marquardt is frequently employed. Levenberg-Marquardt iteratively linearizes a function to be minimized in the neighborhood of the current estimate. This algorithm involves the solution of linear systems known as the normal equations. While effective, even a sparse variant of the Levenberg-Marquardt algorithm which explicitly takes advantage of the normal equations zeros pattern, avoiding storing and operating on zero elements, consumes too much time in the calculation process to be of practical use in applications for which the present invention is deployed.

### FIG. 8

FIG. 8 is a flow chart illustrating steps of a method for generating a 3-D model of an object based on at least two 2-D images of the object according to an embodiment of the invention.

At 805 control points selected by an operator are received. For example, an operator selects a portion, A of a house from a first image including the house. The operator selects the same portion A of the same house from second image including the same house. Display coordinates for operator selected portions of the house depicted in the first and second images are provided to processor. At 807, initial camera parameters are received, e.g., from the operator. At 809 remaining camera parameters are calculated based, at least in part on a camera parameter model. The remaining steps 811 through 825 are carried out as described in FIG. 8.

### FIG. 9

FIG. 9 illustrates and describes a method for minimizing error in a generated 3D model according to an embodiment of the invention.

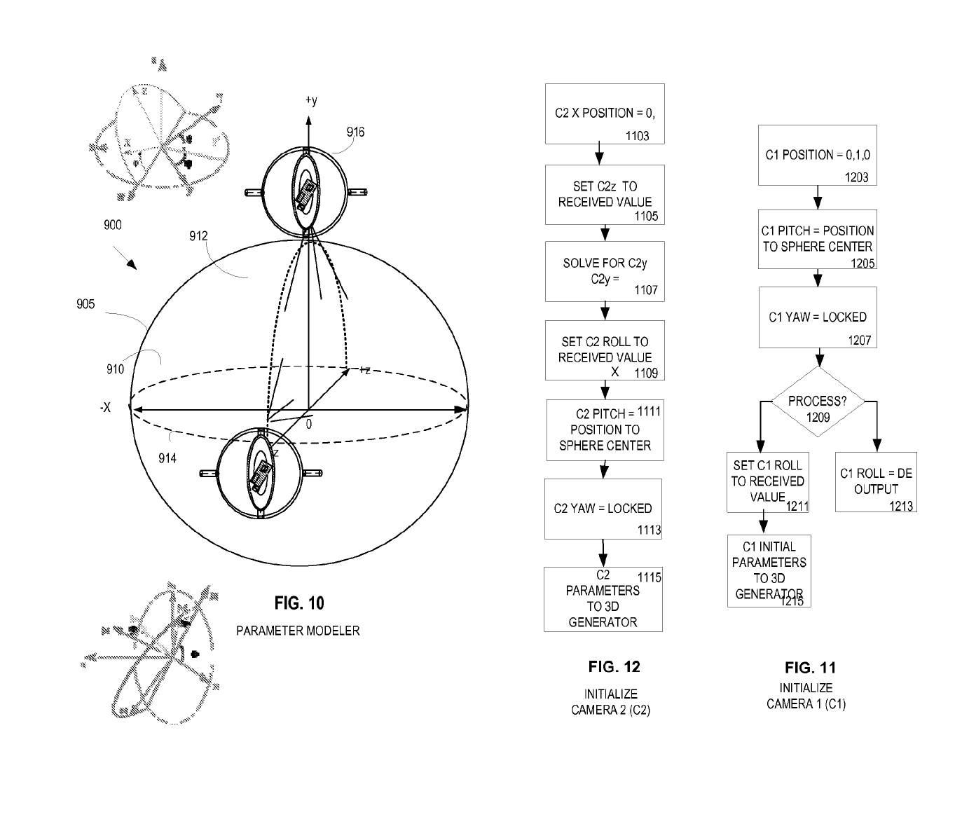

### FIG. 10

In one embodiment of the invention each of the first and second cameras are modeled as a camera mounted on camera bearing platform positioned in 3D model space (915 916). The platform, in turn is coupled to a ‘camera gimbal’. Impossible camera position is thus embodied as a ‘gimbal lock’ position. Gimbal lock is the loss of one degree of freedom in a three-dimensional space that occurs when the axes of two of the three gimbals are driven into a parallel configuration, “locking” the system into rotation in a two-dimensional space.

The model of FIG. 10 represents one advantageous configuration and method for rapidly determining optimal 1^{st} and 2^{nd} camera matrices for projecting 2-D image control points to a model space according to an embodiment of the invention. According to the model initial parameters for first and second camera matrices assume that apertures of the corresponding hypothetical cameras (915, 916) are arranged as to be directed toward the center of sphere 905. Further, one camera 916 is modeled as positioned with respect to sphere 901 at coordinates x0, y1, z0, of coordinate axis 1009 i.e., positioned at the top of the upper hemisphere of the sphere with its aperture aimed directly downward toward the center of the sphere.

In addition, the range of possible positions is constrained to positions on the surface of the sphere and further to the upper hemisphere of the sphere. Further, the x axis position of camera 915 is set to remain at x=0. Accordingly positions assumed by camera 915, conforming to the above constraints, will lie on the z axis between z=1 and z=−1, wherein position of camera 915 with respect to the y axis is determined by z axis position. Each of cameras 915 and 916 are free to rotate about their respective optical axes.

The arrangement illustrated in FIG. 10 provides camera matrix initialization parameters that facilitate convergence of 3-D point estimates from an initial estimate to an estimate meeting defined convergence criteria.

Initial values thus obtained for intrinsic camera parameters are established during an initialization step of the methods illustrated in FIGS. 11 and 12. These are not changed during execution of the method. On the other hand, permutations of extrinsic parameters for successive iterations of simulation methods of the invention are reduced by fixing the position of one camera along two axes, and fixing the position of the other camera along one axis.

### FIG. 11 Parameter Method

FIG. 11 illustrates and describes a method for determining camera 1 (C1) pitch, yaw and roll, based on C1 initial parameters given by the parameter model illustrated in FIG. 10.

### FIG. 12—Parameter Method

Likewise, FIG. 12 illustrates and describes a method for determining camera 2 (C2) pitch, yaw and roll, based on C2 initial parameters given by the parameter model illustrated in FIG. 10.

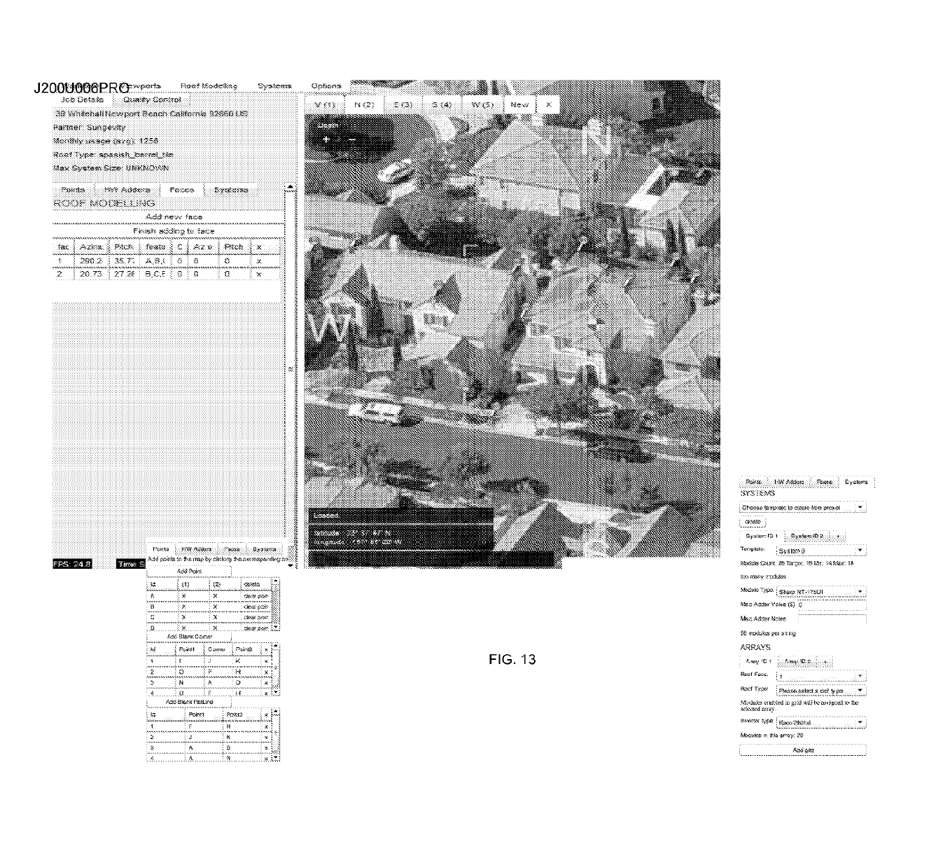

### FIG. 13—Example GUI Screenshot

FIG. 13 is a screenshot of a graphical user interface enabling an operator to interact with displayed first and second images according to an embodiment of the invention.

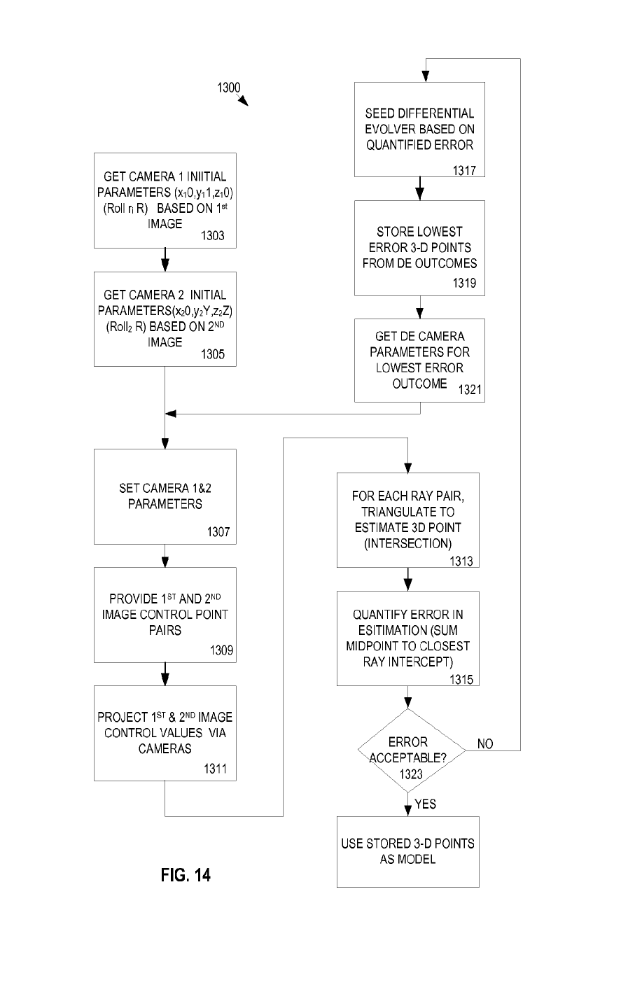

FIG. 14—Simulation Method—Using lowest error output

FIG. 14 is a flowchart illustrating and describing steps of a method for generating a 3D model while minimizing error in the generated 3D model.

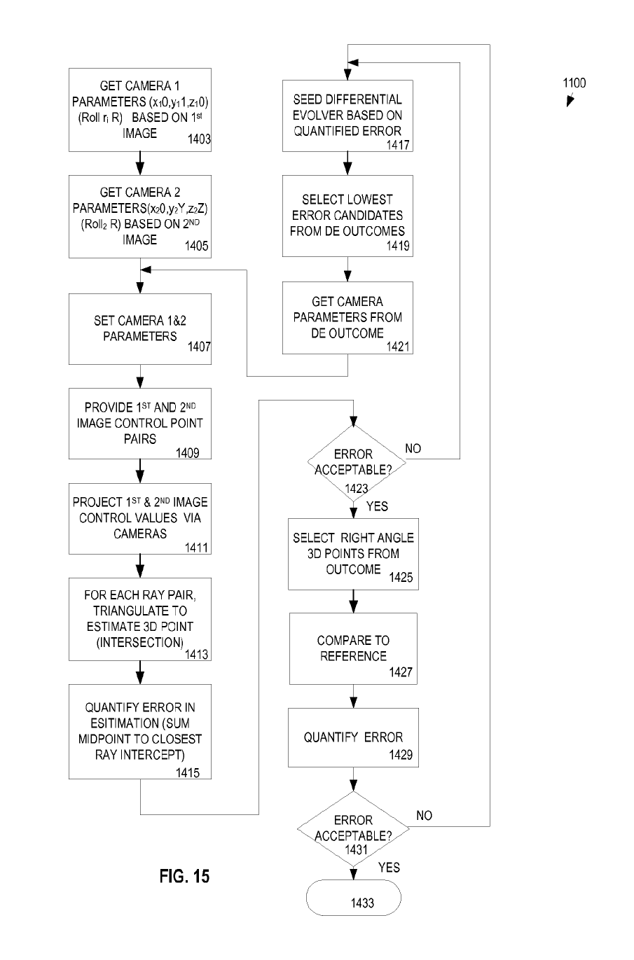

### FIG. 15—Camera Parameter and Simulation Method

FIG. 15 is a flowchart illustrating and describing steps of a method for generating a 3D model according to an embodiment of the invention.

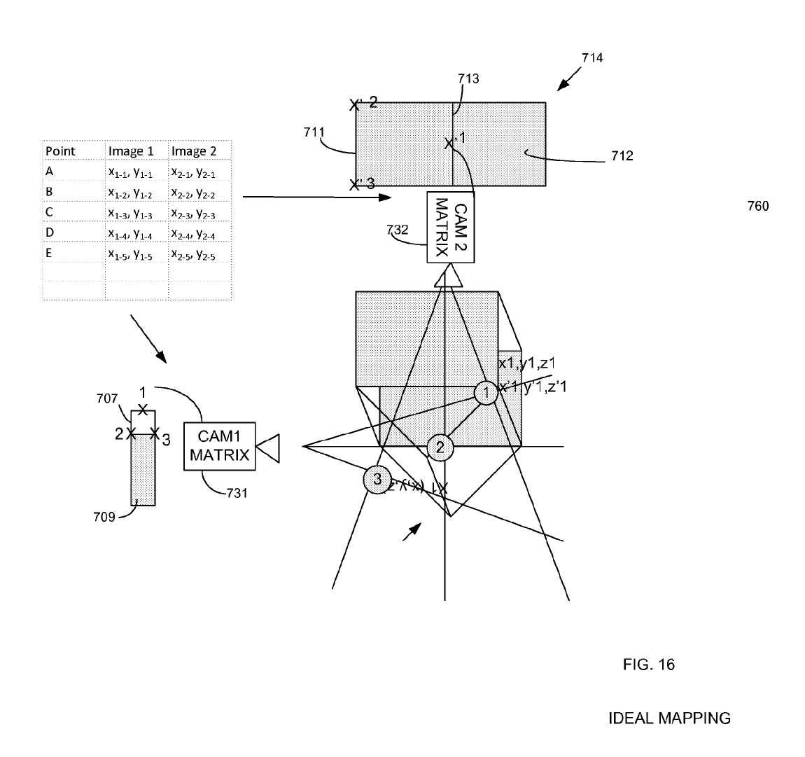

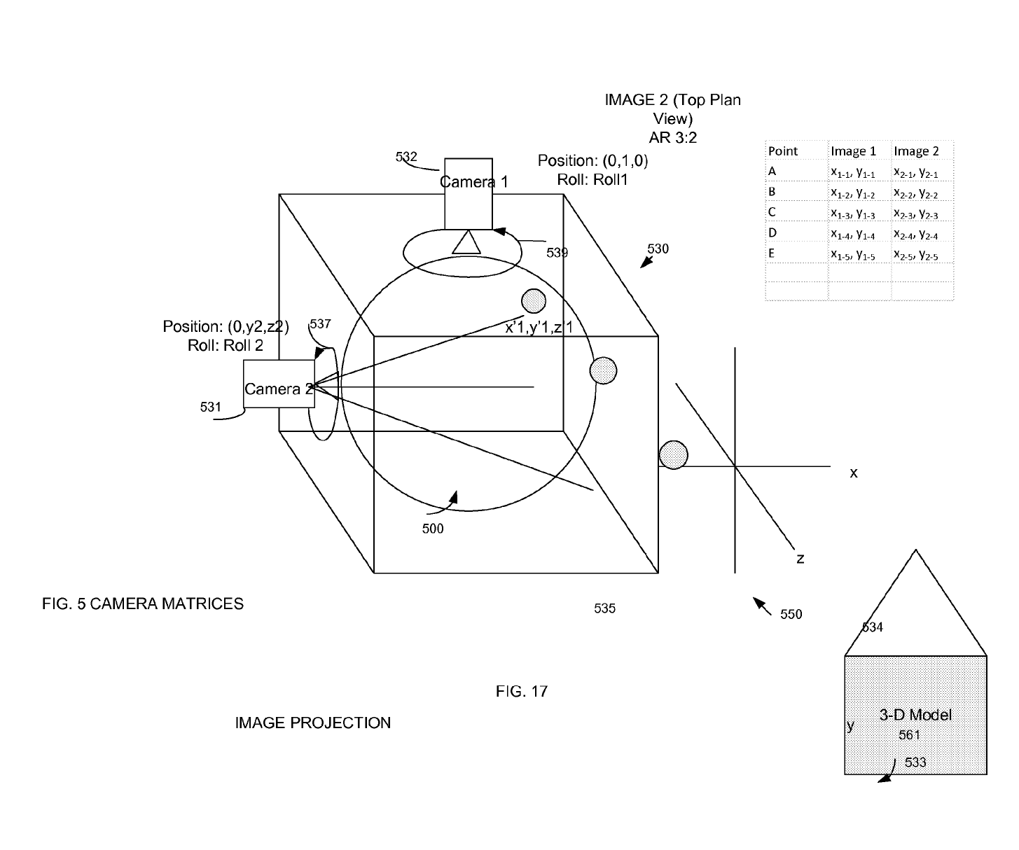

### FIG. 16

is a conceptual diagram illustrating an example 3D model generator providing a 3D model based projection of point sets from first and second images according to an embodiment of the invention. FIG. 16 depicts, at 1, 2 and 3, the 3D points of a 3D model that correspond to the 2D points in the first and second images. A 3D model generator operates on the control point pairs to provide a corresponding 3D point for each control point pair. For first and second image points of first and second images respectively (corresponding to the same three-dimensional point) the image points and the three-dimensional point and the optical centers are coplanar.

An object in 3D space can be mapped to the image of the object in the 2D space of an image through the viewfinder of the device that captured the image by perspective projection transformation techniques. The following parameters are sometimes used to describe this transformation:
a_{x,y,z}—the point in real world 3D space that is to be projected.
c_{x,y,z}—the actual real world location of the camera.
θ_{x,y,z}—The rotation of the real world camera. When c_{x,y,x}= [symbol] 0,0,0 [symbol] and θ_{x,y,z}= [symbol] 0,0,0 [symbol] the 3D vector <1,2,0> is projected to the 2D vector <1,2>.

e_{x,y,z}—the viewer's position relative to the real world display surface.

Which results in:
b_{x,y}—the 2D projection of a.

The invention employs the reverse transformation of the above. In other words, the invention maps a point on an image of the object in the 2D space, as viewed through the viewfinder of the device that captured the image. To accomplish this, the invention provides cam 1 matrix 731 and camera 2 matrix 732 to reconstruct the 3D real world object in model form by projecting point pairs onto 3D model space 760.

Camera matrix 1 and 2 are defined by camera parameters. Camera parameters may include ‘intrinsic parameters’ and ‘extrinsic parameters’. Extrinsic parameters define an exterior orientation of a camera, e.g., location in space and view direction. Intrinsic parameters define the geometric parameters of the imaging process. This is primarily the focal length of the lens, but can also include the description of lens distortions.

Accordingly, a first camera model (or matrix) comprises a hypothetical description of the camera that captured the first image. A second camera model (or matrix) comprises a hypothetical description of the camera that captured the second image. In some embodiments of the invention, camera matrices 731 and 732 are constructed using camera resectioning techniques. Camera resectioning is the process of finding the true parameters of the camera that produced a given photograph or video. Camera parameters are represented in a 3×4 matrices comprising Camera Matrix 1 and 2.

### FIG. 17—Camera Matrices and Model Space

FIG. 17 illustrates a 3D model space into which control points are projected by first and second camera models.

The term ‘camera model’ as used herein refers to a 3×4 matrix which describes the mapping of 3D points comprising a real world object through a pinhole camera to 2D points in a 2D image of the object. In that case, the 2D scene, or photographic frame is referred to as a viewport.

The distance between the camera and the projection plane, d; and the dimensions of the viewport, vw and vh. These values taken together determine the field of view of the projection, that is, the angle which is visible in the projected image:

### Projectors

The first and second camera matrices project a ray from each 2-D control point from first and second images through a hypothetical camera configured in accordance with the camera model and into the 3-D image space in which the 3-D model will be provided.

Thus each camera matrix projects rays in accordance with its own camera matrix parameter settings. Since actual camera parameters for the cameras providing 1^{st} and 2^{nd} images are not known, one approach is to estimate the camera parameters.

It is also known that a given set of 2-D points to be projected via first and second camera matrices correspond to the same point in an ideal projection into a 3-D model. With this knowledge camera parameter estimation according to principles of the invention comprises steps of providing manually estimated initial values, testing for convergence, and adjusting the camera matrices based on the results of the convergence test.

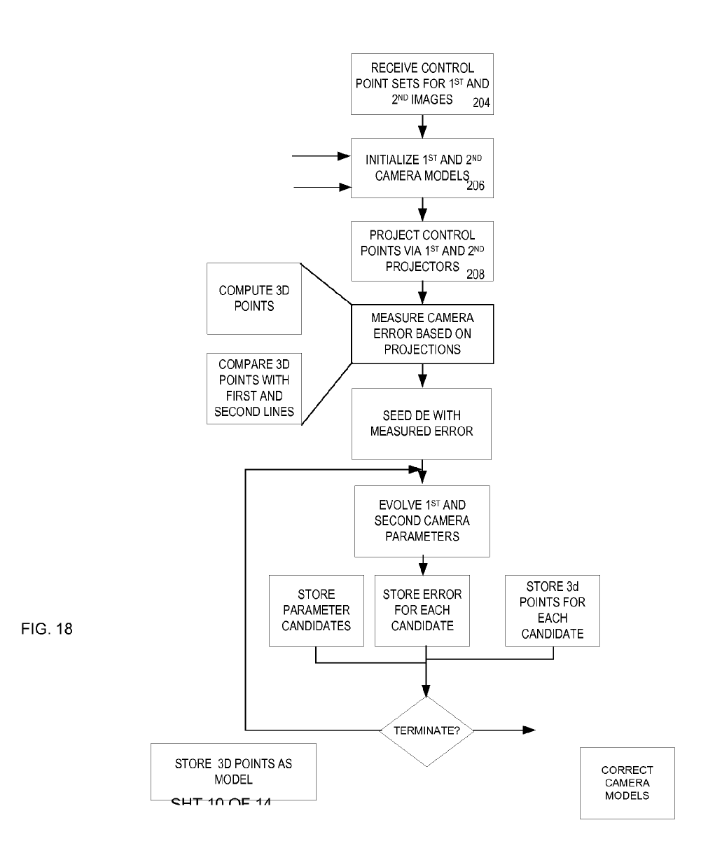

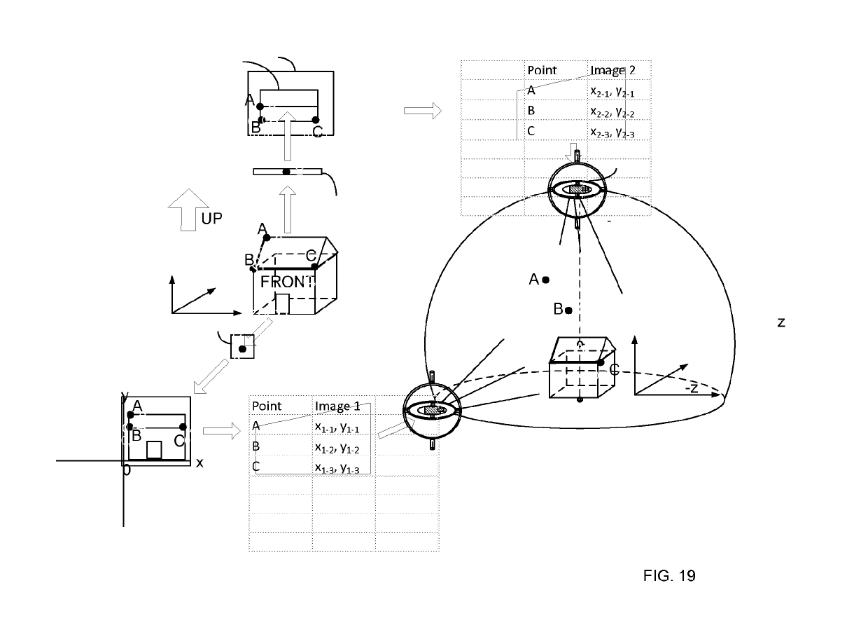

### FIG. 18—Image Registration Method

FIG. 18 illustrates and describes steps of a method for registering first and second images with respect to each other according to an embodiment of the invention.

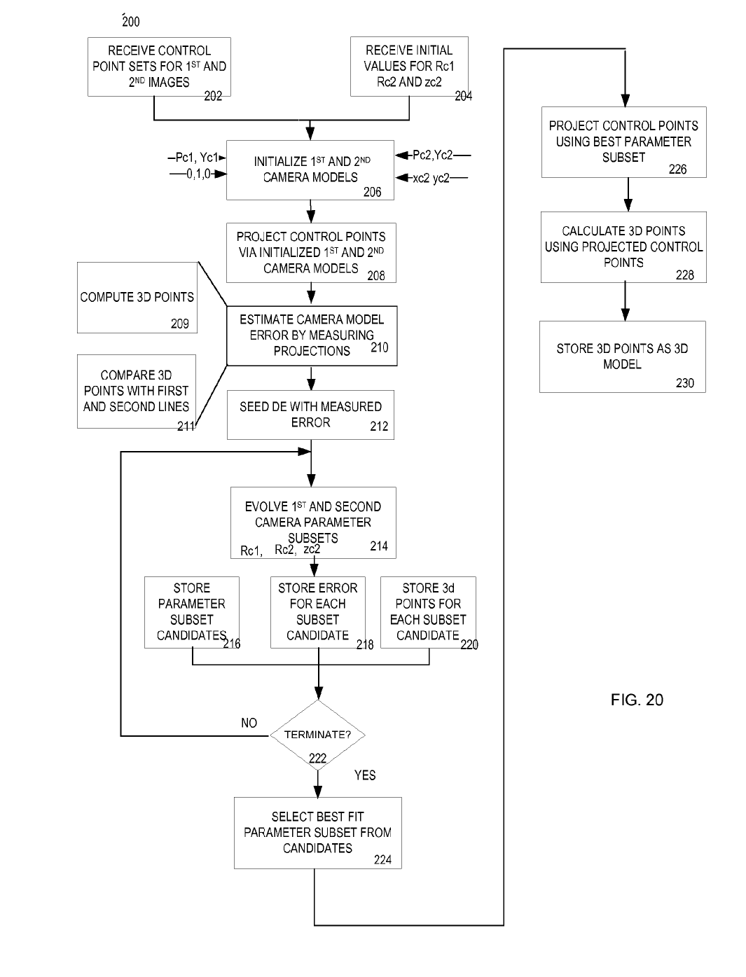

### FIG. 20 Method for 3D Model Generation

FIG. 20 illustrates and describes steps of a method for bundle adjustment according to an embodiment of the invention.

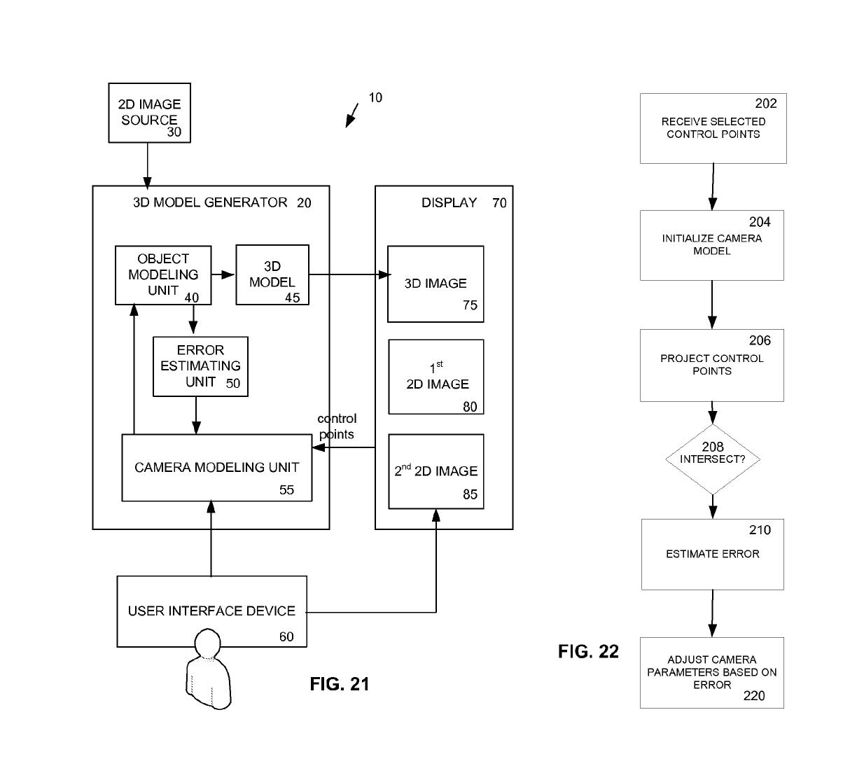

### FIG. 21 Model Generator

FIG. 21 is a block diagram of a 3D model generator according to an embodiment of the invention.

### FIG. 22 Model Generating Method Overview

FIG. 22 is a flowchart illustrating and describing steps of a method for bundle adjustment according to an embodiment of the invention.

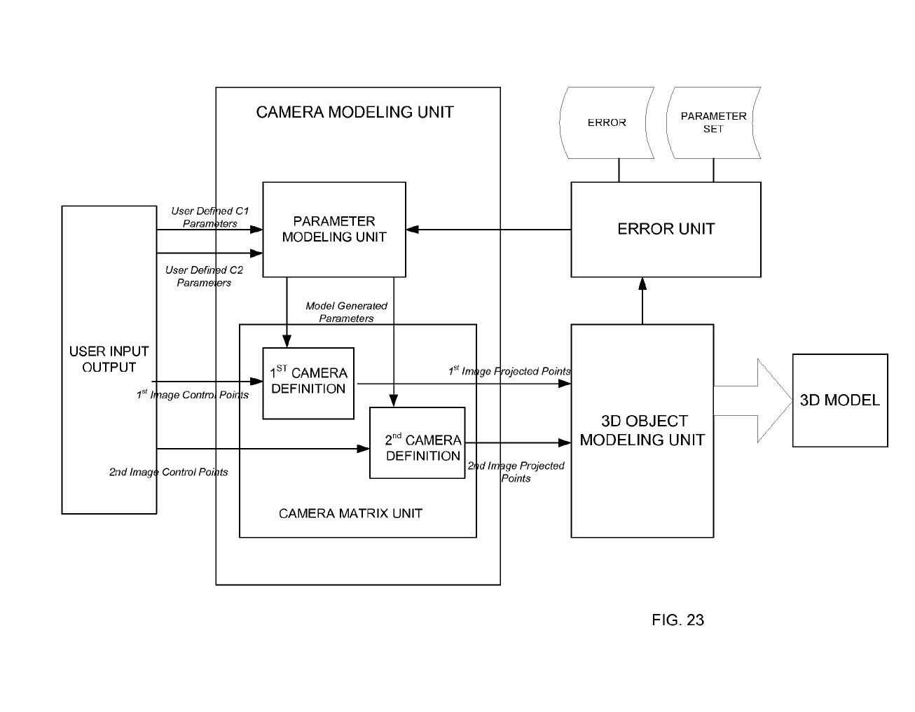

### FIG. 23 Model Generator Embodiment

FIG. 23 is a block diagram of a camera modeling unit according to an embodiment of the invention.

The components comprising system 100 are implementable as separate units and alternatively integrated in various combinations. The components are implementable in a variety of combinations of hardware and software.

While the present invention has been described as having a preferred design, the invention can be further modified within the spirit and scope of this disclosure. This disclosure is therefore intended to encompass any equivalents to the structures and elements disclosed herein. Further, this disclosure is intended to encompass any variations, uses, or adaptations of the present invention that use the general principles disclosed herein. Moreover, this disclosure is intended to encompass any departures from the subject matter disclosed that come within the known or customary practice in the pertinent art and which fall within the limits of the appended claims. While the invention has been shown and described with respect to particular embodiments, it is not thus limited. Numerous modifications, changes and enhancements will now be apparent to the reader.

What is claimed is:

1. A system for generating a 3D model of a real world object comprising:
a camera modeler comprising:
a first input receiving camera parameters;
a second input receiving first and second point sets corresponding to points on respective first and second images of a first object,
the camera modeler providing projections of the first and second point sets into a 3D space in accordance with the camera parameters;
an object modeler comprising:
an input receiving the projections;
a first output providing a 3D model of the first object based on the projections;
a second output providing an estimate of projection error;
the system adjusting, at least one camera parameter in accordance with the estimate of projection error,
the camera modeling unit projecting the first and second point sets based upon the at least one adjusted camera model parameter, thereby enabling the object modeler to provide an error corrected 3D model of the first object.

2. The system of claim 1 further comprising a rendering unit including an input for receiving the error corrected 3D model, the rendering unit providing a 2D representation of the first object based on the error corrected 3D model.

3. The system of claim 2 further comprising:
a 2D display device including an input receiving the 2D representation of the error corrected 3D model, the display device displaying the 2D representation of the first object;
an operator control device coupled to the display device to enable the operator to interact with the 2D representation of the first object to measure dimensions of the object.

4. The system of claim 1 further including:
a display device configured to display first and second 2D images of the real world 3D object;
an operator input device coupled to the display device to enable an operator to interact with the displayed 2D images to define the first and second point sets.

5. The system of claim 4 wherein the 2D display device is configured to further display at least one image of a second object and wherein the operator control device is configured to enable the operator to position the image of the second object within one of the displayed first image, the displayed second image, a displayed rendered image based on the error corrected 3D model.

6. A method for generating a 3D model of an object comprising:
initializing a camera modeler with first and second initial camera parameters;
receiving by the camera modeler first and second 2D point sets corresponding to points on the object appearing in first and second 2D images of the object;
projecting by the camera modeler the first and second 2D points sets into a 3D model space;
determining 3D coordinates to comprise a 3D model of the object based on the projections;
determining an error associated with the projected first and second 2D point sets;
adjusting at least one of the initial camera parameters in accordance with the error, such that the first and second 2D point sets are re-projected in accordance with a corrected camera parameter;
determining 3D coordinates to comprise the 3D model of the object based on the re-projected first and second 2D point sets.

7. The method of claim 6 wherein the steps of generating projections, determining 3D coordinates, determining an error and adjusting a camera parameter are repeated until the determined error is less than or equal to a predetermined error.

8. The method of claim 7 wherein the steps repeating and determining error are carried out by evolving at least one camera parameter to optimize time to converge on the predetermined error.

9. The method of claim 6 including a further step of rendering the error corrected 3D model for display on a display device.

10. The method of claim 6 including further steps of:
receiving a third set of points representing a second object appearing in a third image;
adjusting the scale and orientation of the represented second object to match the scale and orientation of the first object by operating on the third set of points in the 3D model space;
displaying the second object with the displayed first object.
